(19) United States
(12) Patent Application Publication
(10) Pub. No.: US 2026/0315966 A1
(43) Pub. Date: Oct. 15, 2026

(54) FILTER MECHANISM WITH PRESSABLE QUICK-RELEASE FILTER CARTRIDGE ASSEMBLY

(71) Applicant: Chung Yeung LEE, Sai Kung (HK)

(72) Inventor: Chung Yeung LEE, Sai Kung (HK)

(21) Appl. No.: 19/537,058

(22) Filed: Feb. 11, 2026

(30) Foreign Application Priority Data
Apr. 9, 2025 (CN) 2025206716362

(51) Int. Cl. B01D 29/96; B01D 29/15; B01D 46/00; B01D 46/24

(52) U.S. Cl. CPC B01D 29/96; B01D 29/15; B01D 46/0005; B01D 46/2411; B01D 2201/295; B01D 2201/302

(57) ABSTRACT

A filter mechanism, including an outer housing having a water inlet and a water outlet, and an accommodating cavity inside the outer housing. A filter cartridge assembly is positioned in the accommodating cavity and is detachably connected to the accommodating cavity through at least two elastic snap-fit assemblies. One end of the filter cartridge assembly has a pressing portion extending to an exterior of the accommodating cavity. A first elastic member is positioned between an opposite end of the filter cartridge assembly and the outer housing. A side wall of the filter cartridge assembly defines a snap-fit groove, into which the elastic snap-fit assemblies extend. A movable member is movably positioned in the snap-fit groove. Under an external pressing force and/or an elastic force of the first elastic member, the filter cartridge assembly moves relative to the accommodating cavity.

### TECHNICAL FIELD

The present invention relates to the technical field of filter mechanisms, and in particular to a filter mechanism with a pressable quick-release filter cartridge assembly, wherein the filter mechanism can be applied in products such as shower devices, faucets, and water purifiers.

### BACKGROUND OF THE INVENTION

With the development of industry and the trend of population urbanization, pollution of natural water resources is becoming increasingly serious. Tap water that we often use contains harmful substances such as water impurities, heavy metal ions, organic gases, and residual chlorine. In order to reduce harmful effects of the harmful substances in tap water to the human body, some existing faucets or shower devices are provided with filter cartridge assemblies for filtering harmful substances. However, after a period of use, the filter cartridge assemblies become contaminated by the harmful substances. To avoid secondary pollution of water by the contaminated filter cartridge assemblies, it is necessary to regularly clean or replace the filter cartridge assemblies in the faucets or shower devices. For example, CN201832727U discloses a filtered showerhead, in which a water quality purification device (i.e., a filter cartridge assembly) is removably provided at a water inlet of a showerhead handle through a plug nut having a through water channel and a plug. After applying force to unscrew the plug from the plug nut, the water quality purification device can be removed from the showerhead handle for cleaning or replacement. Another example is CN220572866U which discloses a faucet water purifier that can be quickly installed. It achieves fixed installation of a filter tube and a valve tube by inserting an elastic latch of a frame into an insertion hole of an insertion block, and a filter cartridge assembly for purifying and filtering tap water is placed on a support ring on an inner wall of the filter tube, thereby making the faucet water purifier convenient for disassembly and replacement of the filter cartridge assembly.

However, in the above-mentioned showerhead or faucet water purifier, when assembling or disassembling the filter cartridge assembly, it is necessary to assemble or disassemble other components as well to complete the assembly or disassembly of the filter cartridge assembly. The steps involved are relatively cumbersome, the operation is inconvenient, and it is time-consuming and labor-intensive.

Therefore, it is necessary to provide some technical solutions to solve the above problems.

### BRIEF SUMMARY OF THE INVENTION

It is an object of the present invention to provide a filter mechanism with a pressable quick-release filter cartridge assembly, which can solve the technical problems in the prior art that the disassembly and assembly steps of the filter cartridge assembly are relatively cumbersome.

To attain the above object, the present invention provides the following technical solutions:
A filter mechanism, comprising an outer housing, a filter cartridge assembly, and at least two elastic snap-fit assemblies; the outer housing is provided with a water inlet and a water outlet; an accommodating cavity is provided inside the outer housing; the filter cartridge assembly is disposed in the accommodating cavity and is detachably connected to the accommodating cavity via said at least two elastic snap-fit assemblies; one end of the filter cartridge assembly is provided with a pressing portion, and the pressing portion extends out of the accommodating cavity; a first elastic member is disposed between another end of the filter cartridge assembly facing away from the pressing portion and the outer housing; a periphery of the filter cartridge assembly is provided with a snap-fit groove; said at least two elastic snap-fit assemblies are capable of extending into the snap-fit groove; a movable member is movably disposed in the snap-fit groove; under an action of an external pressing force and/or an elastic force of the first elastic member, the filter cartridge assembly is capable of moving relative to the accommodating cavity; during movement of the filter cartridge assembly relative to the accommodating cavity, each of said at least two elastic snap-fit assemblies is capable of moving between an extended position and a retracted position under action of the movable member, and the movable member is capable of moving in the snap-fit groove under action of said at least two elastic snap-fit assemblies.

Further, at least two installation grooves are provided in the accommodating cavity corresponding to a position of the snap-fit groove when the filter cartridge assembly is installed, and each of said at least two installation grooves is installed with a respective one of said at least two elastic snap-fit assemblies.

Further, each of said at least two elastic snap-fit assemblies comprises at least one second elastic member and a snap-fit block connected to an end of said at least one second elastic member facing towards the filter cartridge assembly; the snap-fit block is capable of extending into the snap-fit groove during the extended position of a corresponding elastic snap-fit assembly; an end of the snap-fit block facing towards the filter cartridge assembly is provided with a first inclined surface, and an outer end of the movable member facing away from the filter cartridge assembly is provided with a second inclined surface corresponding to the first inclined surface.

Further, along a direction from the pressing portion to the first elastic member, a width between the first inclined surface and a central axis of the filter cartridge assembly gradually decreases, and conversely, a width between the second inclined surface and the central axis of the filter cartridge assembly gradually increases.

Further, the filter cartridge assembly comprises a filter cartridge cylinder; an interior of the filter cartridge cylinder is provided with a filter material accommodating cavity; one end of the filter cartridge cylinder communicates with the water inlet, and another end of the filter cartridge cylinder communicates with the water outlet.

Further, said one end of the filter cartridge cylinder is provided with a first opening, and said another end of the filter cartridge cylinder is provided with a plurality of first through apertures; a filter cartridge cover is detachably connected at the first opening, and the filter cartridge cover is provided with a plurality of second through apertures.

Further, the filter cartridge assembly further comprises a mounting seat; an interior of the mounting seat is provided with a mounting cavity; said another end of the filter cartridge cylinder which is proximal to the pressing portion is detachably disposed in the mounting cavity and communicates with the mounting cavity; a through groove is provided on the mounting seat or between the mounting seat and the filter cartridge cylinder; the mounting cavity communicates with the water outlet through the through groove; the snap-fit groove is disposed on a peripheral side wall of the mounting seat; the pressing portion is disposed at one end of the mounting seat facing away from the first elastic member.

Further, the filter cartridge assembly further comprises an aromatherapy assembly detachably disposed in the mounting cavity.

Further, the filter cartridge assembly further comprises a movable sleeve; the movable sleeve is disposed in the accommodating cavity; one end of the movable sleeve facing away from the pressing portion communicates with the water inlet, and another end of the moveable sleeve facing towards the pressing portion is provided with a second opening; said one end of the filter cartridge cylinder facing away from the pressing portion is detachably inserted into the movable sleeve through the second opening; the first elastic member is disposed between said one end of the movable sleeve facing away from the pressing portion and the outer housing; an end face of another end of the mounting seat facing away from the pressing portion abuts against an end face of another end of the movable sleeve facing towards the pressing portion; under the action of the external pressing force and/or the elastic force of the first elastic member, the movable sleeve is capable of moving relative to the accommodating cavity.

The present invention has the following beneficial effects:
(1) Through deliberated cooperation of said at least two elastic snap-fit assemblies, the movable member, and the snap-fit groove, as well as cooperation of the external pressing force and the elastic force of the first elastic member, it is only necessary to press the pressing portion of the filter cartridge assembly towards the first elastic member regardless of installing or disassembling the filter cartridge assembly. Therefore, it is not necessary to install or disassemble other components, and the operation steps are simple and quick. Moreover, during the process of installing or disassembling the filter cartridge assembly, there is no need to remove the filter mechanism. The filter mechanism according to the present embodiment can be perfectly adapted to various types of products such as shower devices, faucets, and water purifiers.
(2) By providing the movable sleeve, the filter mechanism is allowed to function normally regardless of whether the filter cartridge cylinder is installed, thereby meeting different usage needs of users.

### BRIEF DESCRIPTION OF THE DRAWINGS

FIG. 1 is a schematic diagram of an overall structure of the filter mechanism according to Embodiments 1 and 2 embodied in a showerhead.

FIG. 2 is a schematic exploded diagram of a partial structure of the filter mechanism according to Embodiments 1 and 2 embodied in a showerhead.

FIG. 3 is a schematic cross-sectional structural diagram of the filter mechanism according to Embodiment 1 embodied in a showerhead.

FIG. 4 is an enlarged schematic structural diagram of portion A in FIG. 3.

FIG. 5 is a schematic exploded structural diagram of the filter mechanism according to Embodiment 1 embodied in a showerhead.

FIG. 6(a)-6(c) are schematic diagrams of a disassembly process of the filter cartridge assembly according to Embodiment 1.

FIG. 7 is a schematic cross-sectional structural diagram of the filter mechanism according to Embodiment 2 embodied in a showerhead.

FIG. 8 is a schematic cross-sectional structural diagram of the filter mechanism according to Embodiment 2 embodied in a showerhead in a state without a filter cartridge cylinder.

FIG. 9 is a schematic exploded structural diagram of the filter mechanism according to Embodiment 2 embodied in a showerhead.

FIG. 10(a)-10(c) are schematic diagrams showing the movable sleeve moving relative to the accommodating cavity according to Embodiment 2, wherein the filter cartridge cylinder is omitted from illustration.

### DETAILED DESCRIPTION OF THE INVENTION

In order to facilitate understanding by those skilled in the art, the present invention is further described below with reference to some embodiments and the accompanying drawings. The specific details mentioned in the embodiments are not intended to limit the present invention.

### Embodiment 1

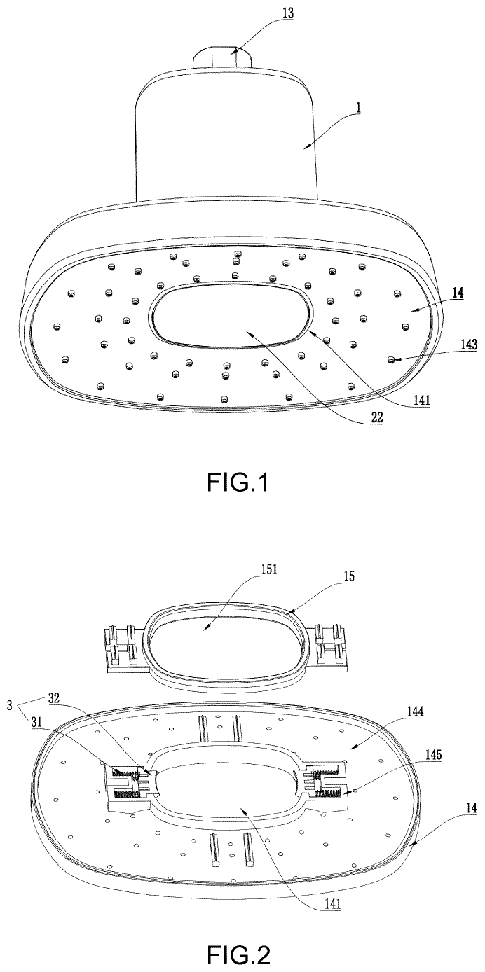

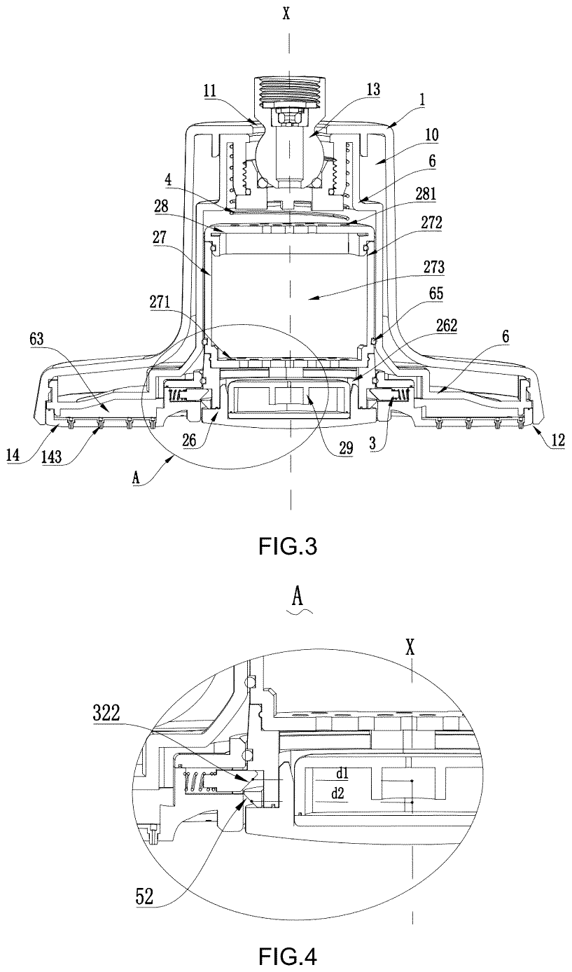

A structure of a filter mechanism with a pressable quick-release filter cartridge assembly is described below with reference to FIGS. 1-6, wherein the filter mechanism is particularly embodied in a showerhead.

As shown in FIGS. 1-6, the filter mechanism of the present embodiment comprises an outer housing 1, a filter cartridge assembly 2 which is pressable and quickly releasable, and at least two elastic snap-fit assemblies 3. The outer housing 1 is provided with a water inlet 11 and a water outlet 12. An accommodating cavity 10 is provided inside the outer housing 1. The filter cartridge assembly 2 is disposed in the accommodating cavity 10 and is detachably connected to the accommodating cavity 10 via said at least two elastic snap-fit assemblies 3. One end of the filter cartridge assembly 2 is provided with a pressing portion 22, and the pressing portion 22 extends out of the accommodating cavity 10. A first elastic member 4 is disposed between another end of the filter cartridge assembly 2 away from the pressing portion 22 and the outer housing 1. A periphery of the filter cartridge assembly 2 is provided with a snap-fit groove 25. Said at least two elastic snap-fit assemblies 3 is capable of extending into the snap-fit groove 25. A movable member 5 is movably disposed in the snap-fit groove 25. Under an action of an external pressing force F1 and/or an elastic force of the first elastic member 4, the filter cartridge assembly 2 is capable of moving relative to the accommodating cavity 10. During movement of the filter cartridge assembly 2, said at least two elastic snap-fit assemblies 3 and the movable member 5 are capable of contacting each other, and each of said at least two elastic snap-fit assemblies 3 is capable of moving between an extended position and a retracted position under action of the movable member 5, and the movable member 5 is capable of moving in the snap-fit groove 25 under action of said at least two elastic snap-fit assemblies 3. The first elastic member 4 is a spring. Specifically, when the filter mechanism of the present embodiment is embodied in a showerhead, a joint 13 is installed in the water inlet 11, a water outlet panel 14 is installed in the water outlet 12, and a center area of the water outlet panel 14 is provided with a first through hole 141 through which the filter cartridge assembly 2 passes through, so as to facilitate insertion and subsequent installation of the filter cartridge assembly 2 into the showerhead through the first through hole 141. The pressing portion 22 extends out of the accommodating cavity 10 through the first through hole 141 to facilitate a user to apply a pressing force on the pressing portion 22. A plurality of water outlet holes 143 are provided on the water outlet panel 14 around the first through hole 141. The joint 13 is a universal joint to facilitate adjustment of an angle of the showerhead.

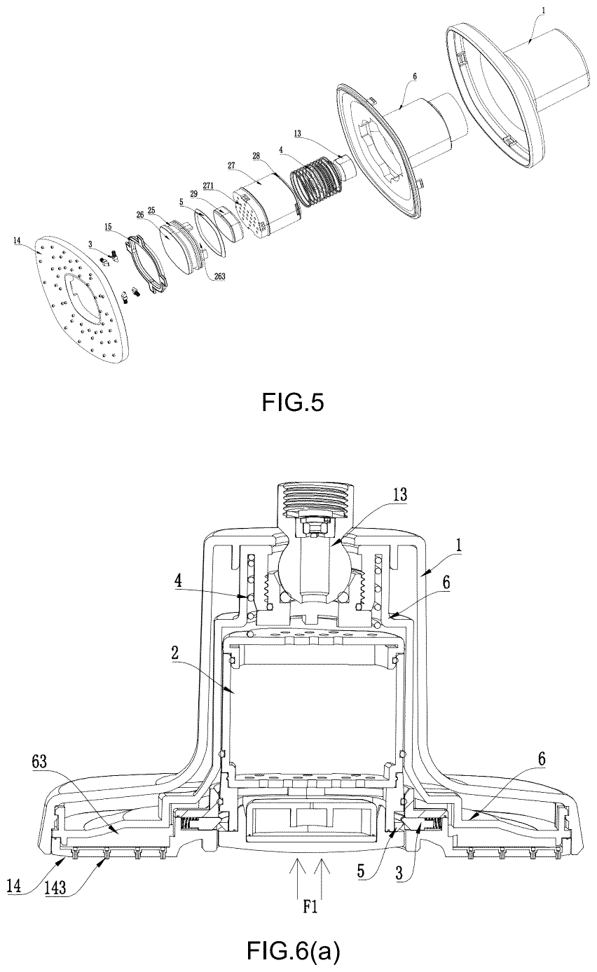

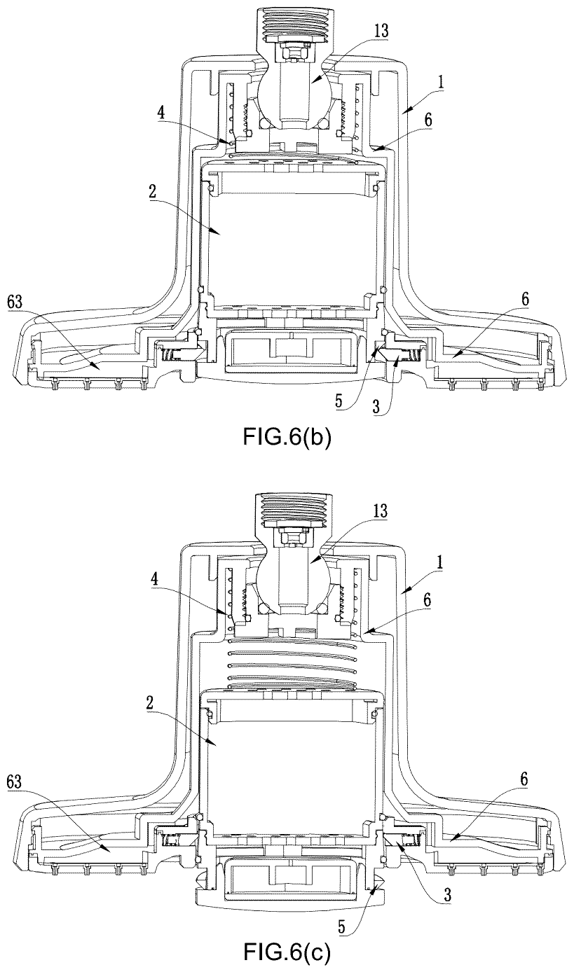

During actual use, when it is necessary to disassemble the filter cartridge assembly 2 from the filter mechanism, press the pressing portion 22 with a hand, as shown in FIG. 6(a), to apply a pressing force F1 to the pressing portion 22. The filter cartridge assembly 2, driven by the pressing portion 22 under the pressing force F1, moves towards the first elastic member 4 together with the movable member 5 disposed on one side of the snap-fit groove 25 of the filter cartridge assembly 2. During such movement of the filter cartridge assembly 2, the first elastic member 4 is compressed, and the movable member 5 abuts against said at least two elastic snap-fit assemblies 3 and applies force to said at least two elastic snap-fit assemblies 3, causing said at least two elastic snap-fit assemblies 3 to retract to a retracted position. When the filter cartridge assembly 2 reaches a predetermined maximum stroke of its movement towards the first elastic member 4, the movable member 5 has moved past said at least two elastic snap-fit assemblies 3, that is to say, the movable member 5 is now closer to the first elastic member 4 than said at least two elastic snap-fit assemblies 3, and each of said at least two elastic snap-fit assemblies 3 resets to an extended position. At this time, release the hand to withdraw the pressing force F1, and the first elastic member 4 resets to drive the filter cartridge assembly 2 to move in an opposite direction away from the first elastic member 4, as shown in FIG. 6(b). At this time, said at least two elastic snap-fit assemblies 3 block the movable member 5 from moving together with the filter cartridge assembly 2, causing said at least two elastic snap-fit assemblies 3 to drive the movable member 5 to gradually move to abut another opposite side of the snap-fit groove 25 proximal to the first elastic member 4 as opposed to said one side of the snap-fit groove 25 away from the first elastic member 4 which the first movable member 5 is disposed in as shown in FIG. 6(a). When the movable member 5 abuts said another opposite side of the snap-fit groove 25 proximal to the first elastic member 4, under the elastic force of the first elastic member 4, the snap-fit groove 25 of the filter cartridge assembly 2 drives the movable member 5 to move together with the filter cartridge assembly 2 in said opposite direction away from the first elastic member 4. At this time, the movable member 5 applies force to said at least two elastic snap-fit assemblies 3 again, causing said at least two elastic snap-fit assemblies 3 to be compressed again. Accordingly, the movable member 5 moves past said at least two elastic snap-fit assemblies 3, that is, the movable member 5 is now closer to the pressing portion 22 than said at least two elastic snap-fit assemblies 3. At this time, said at least two elastic snap-fit assemblies 3 no longer block the filter cartridge assembly 2, as shown in FIG. 6(c). Accordingly, the filter cartridge assembly 2 at least partially leaves the accommodating cavity 10 under the elastic force of the first elastic member 4, and user can now conveniently remove the filter cartridge assembly 2 from the filter mechanism. When it is necessary to install the filter cartridge assembly 2 back into the filter mechanism, insert the filter cartridge assembly 2 into the accommodating cavity 10 such that a peripheral side wall of the filter cartridge assembly 2 presses against said at least two elastic snap-fit assemblies 3, causing said at least two elastic snap-fit assemblies 3 to be compressed and thus retract to the retracted position, and then press the filter cartridge assembly 2 towards the first elastic member 4 to overcome the elastic force of the first elastic member 4, causing the filter cartridge assembly 2 to move towards the first elastic member 4. Due to gravity, the movable member 5 is now located on said one side of the snap-fit groove 25 shown in FIG. 6(a) proximal to the pressing portion 22 as opposed to said another opposite side of the snap-fit groove 25 proximal to the first elastic member 4 as shown in FIG. 6(b), thus leaving a gap between the movable member 5 and said another opposite side of the snap-fit groove 25 proximal to the first elastic member 4. When the filter cartridge assembly 2 continues to move towards the first elastic member 4, causing the gap of the snap-fit groove 25 to align with said at least two elastic snap-fit assemblies 3, the gap provides no blocking effect against said at least two elastic snap-fit assemblies 3, and so said at least two elastic snap-fit assemblies 3 reset and thereby inserts into the gap. Thus, t said at least two elastic snap-fit assemblies 3 fixe the filter cartridge assembly 2 in the accommodating cavity 10 of the filter mechanism to achieve installation of the filter cartridge assembly 2.

In the present embodiment, through deliberated cooperation of said at least two elastic snap-fit assemblies 3, the movable member 5, and the snap-fit groove 25, as well as cooperation of the external pressing force F1 and the elastic force of the first elastic member 4, it is only necessary to press the pressing portion 22 of the filter cartridge assembly 2 towards the first elastic member 4 regardless of installing or disassembling the filter cartridge assembly 2. Therefore, it is not necessary to install or disassemble other components, and the operation steps are simple and quick. Moreover, during the process of installing or disassembling the filter cartridge assembly 2, there is no need to remove the filter mechanism. The filter mechanism according to the present embodiment can be perfectly adapted to various types of products such as shower devices, faucets, and water purifiers.

Further, at least two installation grooves 145 are provided in the accommodating cavity 10 corresponding to a position of the snap-fit groove 25 when the filter cartridge assembly 2 is installed, and each of said at least two installation grooves 145 is installed with a respective one of said at least two elastic snap-fit assemblies 3. Specifically, when the filter mechanism of the present embodiment is embodied in a showerhead, an inner side surface 144 of the water outlet panel 14 is connected to a cover plate 15, a center area of the cover plate 15 is provided with a second through hole 151 through which the filter cartridge assembly 2 passes through, and said at least two installation grooves 145 are arranged between the cover plate 15 and the water outlet panel 14. In the present embodiment, by providing said at least two installation grooves 145 to facilitate installation of said at least two elastic snap-fit assemblies 3, and by providing said at least two installation grooves 145 and said at least two elastic snap-fit assemblies 3, a fixing effect by said at least two elastic snap-fit assemblies 3 unto the filter cartridge assembly 2 can be ensured.

Further, each of said at least two elastic snap-fit assemblies 3 comprises at least one second elastic member 31 and a snap-fit block 32 connected to an end of said at least one second elastic member 31 facing towards the filter cartridge assembly 2. The snap-fit block 32 is capable of extending into the snap-fit groove 25 during an extended position of a corresponding elastic snap-fit assembly 3. An end of the snap-fit block 32 facing towards the filter cartridge assembly 2 is provided with a first inclined surface 322, and an outer end of the movable member 5 facing away from the filter cartridge assembly 2 is provided with a second inclined surface 52 corresponding to the first inclined surface 322. Preferably, along a direction from the pressing portion 22 to the first elastic member 4, a width, defined by a distance d1, between the first inclined surface 322 and a central axis X of the filter cartridge assembly 2 gradually decreases, and conversely, a width, defined by a distance d2, between the second inclined surface 52 and the central axis X of the filter cartridge assembly 2 gradually increases. Specifically, each of said at least one second elastic member 31 is also a spring. In the present embodiment, by providing the first inclined surface 322, it is convenient for the filter cartridge assembly 2 or the movable member 5 to apply force to the first inclined surface 322 to drive said at least two elastic snap-fit assemblies 3 to retract. By providing the second inclined surface 52, it is convenient for the movable member 5 to move past said at least two elastic snap-fit assemblies 3 during disassembly of the filter cartridge assembly 2, thereby allowing the filter cartridge assembly 2 to at least partially leave the accommodating cavity 10 smoothly under the elastic force of the first elastic member 4.

Further, the filter cartridge assembly 2 comprises a filter cartridge cylinder 27. An interior of the filter cartridge cylinder 27 is provided with a filter material accommodating cavity 273. One end of the filter cartridge cylinder 27 communicates with the water inlet 11, and another end of the filter cartridge cylinder 27 communicates with the water outlet 12. Preferably, said one end of the filter cartridge cylinder 27 is provided with a first opening 272, and said another end is provided with a plurality of first through apertures 271. A filter cartridge cover 28 is detachably connected at the first opening 272, and the filter cartridge cover 28 is provided with a plurality of second through apertures 281. Preferably, the filter cartridge assembly 2 further comprises a mounting seat 26. An interior of the mounting seat 26 is provided with a mounting cavity 262. Said another end of the filter cartridge cylinder 27 proximal to the pressing portion 22 is detachably disposed in the mounting cavity 262 and communicates with the mounting cavity 262. A through groove 263 is provided on the mounting seat 26 or between the mounting seat 26 and the filter cartridge cylinder 27. The mounting cavity 262 communicates with the water outlet 12 through the through groove 263. The snap-fit groove 25 is disposed on a peripheral side wall of the mounting seat 26. The pressing portion 22 is disposed at one end of the mounting seat 26 facing away from the first elastic member 4. During actual use, water enters the filter cartridge cylinder 27 from the second through apertures 281 on the filter cartridge cover 28. The filter material accommodating cavity 273 in the filter cartridge cylinder 27 accommodates a filter material. The water flows out from the first through apertures 271 after being filtered by the filter material, then enters the mounting cavity 262 of the mounting seat 26, and finally flows into the water outlet 12 through the through groove 263. In the present embodiment, by providing the filter cartridge cover 28 detachably connected to the filter cartridge cylinder 27, it is convenient for user to regularly replace the filter material in the filter material accommodating cavity 273 without discarding the entire filter cartridge cylinder 27, reducing usage costs and being energy-saving and environmentally friendly.

Further, the filter cartridge assembly 2 further comprises an aromatherapy assembly 29. The aromatherapy assembly 29 is detachably disposed in the mounting cavity 262. In the present embodiment, by providing the aromatherapy assembly 29, it enables enjoyment of an aromatherapy function while showering.

Specifically, when the filter mechanism according to the present embodiment is embodied in a showerhead, a first inner housing 6 is further provided inside the outer housing 1. One end of the first inner housing 6 communicates with the joint 13, and another end of the first inner housing 6 engages with the water outlet panel 14. A first water passage chamber 63 is formed between the first inner housing 6 and the water outlet panel 14. The first elastic member 4 is disposed between said another end of the filter cartridge assembly 2 away from the pressing portion 22 and the first inner housing 6. The filter cartridge assembly 2 is disposed inside the first inner housing 6. An inner peripheral side wall of the first inner housing 6 and an outer peripheral side wall of the filter cartridge assembly 2 are disposed in close contact with each other, and a sealing ring 65 is disposed therebetween. Thus, when water flows in from the joint 13, the water can only enter the filter cartridge assembly 2 and cannot flow out from between the inner peripheral side wall of the first inner housing 6 and the outer peripheral side wall of the filter cartridge assembly 2, ensuring that the water flowing out from the water outlet 12 has undergone filtration treatment by the filter cartridge assembly 2. The water flowing out from the filter cartridge assembly 2 enters the first water passage chamber 63 through the through groove 263, and finally flows out from the water outlet panel 14.

### Embodiment 2

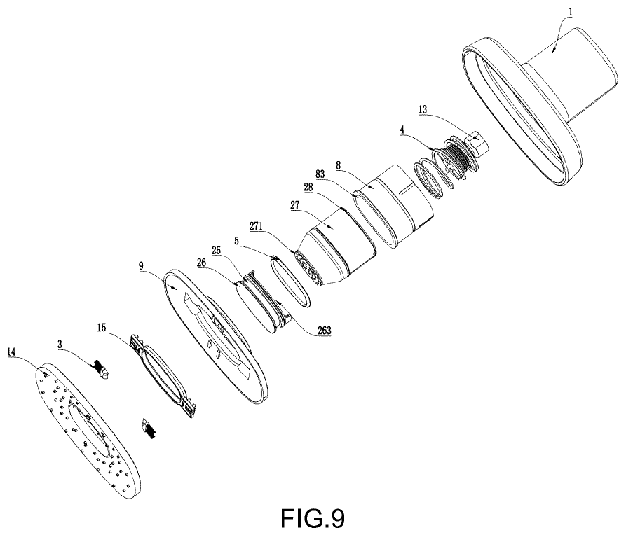

Similarly, another structure of a filter mechanism with a pressable quick-release filter cartridge assembly is described below with reference to FIGS. 1-2, and 7-10(c), wherein the filter mechanism is particularly embodied also in a showerhead.

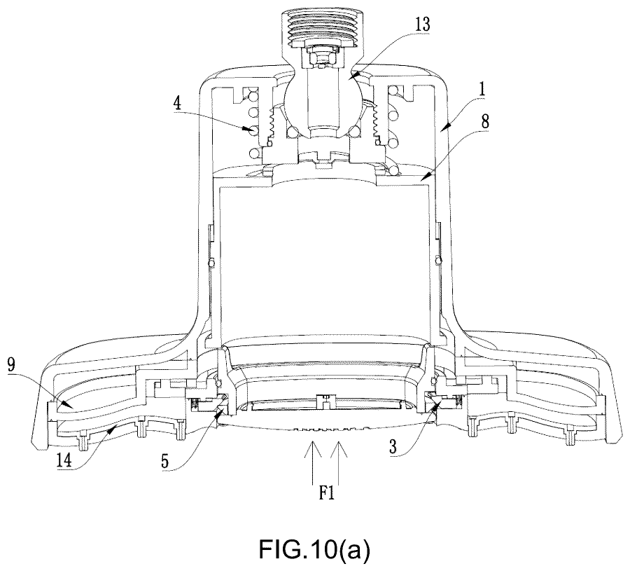

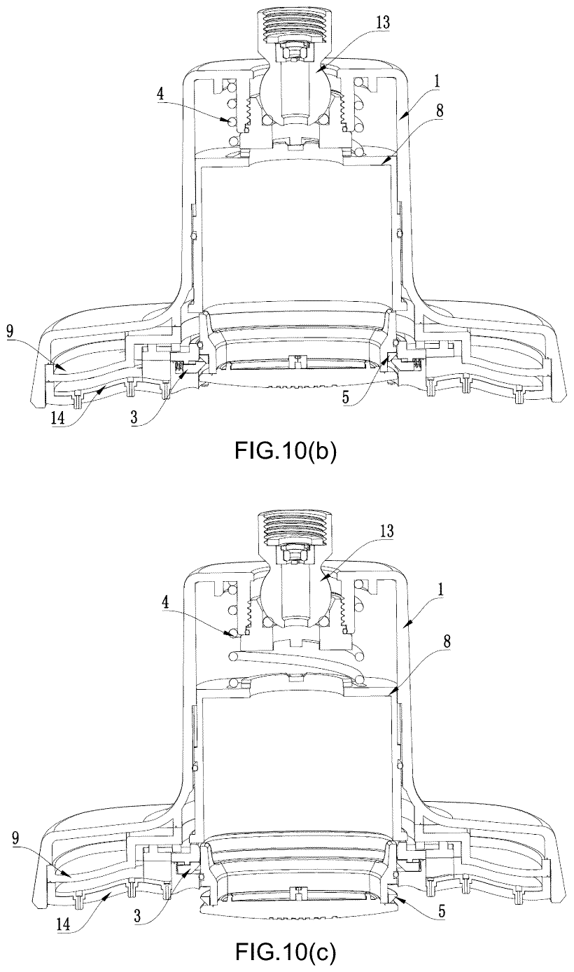

As shown in FIGS. 1-2 and 7-10(c), compared with Embodiment 1, a difference between this embodiment and the previous embodiment 1 lies in that: the filter cartridge assembly 2 further comprises a movable sleeve 8. The movable sleeve 8 is disposed in the accommodating cavity 10. One end of the movable sleeve 8 facing away from the pressing portion 22 communicates with the water inlet 11, and another end facing towards the pressing portion 22 is provided with a second opening 83. Said one end of the filter cartridge cylinder 27 facing away from the pressing portion 22 is detachably disposed in the movable sleeve 8 through the second opening 83. The first elastic member 4 is disposed between said one end of the movable sleeve 8 facing away from the pressing portion 22 and the outer housing 1. An end face of another end of the mounting seat 26 facing away from the pressing portion 22 abuts against an end face of another end of the movable sleeve 8 facing towards the pressing portion 22. As shown in FIG. 10(a) to 10(c), under the action of the external pressing force F1 and/or the elastic force of the first elastic member 4, the movable sleeve 8 is capable of moving relative to the accommodating cavity 10. The principle of how the movable sleeve 8 is capable of moving relative to the accommodating cavity 10 as shown in FIG. 10(a) to 10(c) will not be detailed herein since it is the same as how the filter cartridge assembly 2 moves as previously described with reference to FIG. 6(a) to 6(c) respectively.

Specifically, when the filter mechanism according to the present embodiment is embodied in a showerhead, a second inner housing 9 is further provided inside the outer housing 1. One end of the second inner housing 9 engages with the outer housing 1, and another end of the second inner housing 9 engages with the water outlet panel 14. A second water passage chamber 93 is formed between the second inner housing 9 and the water outlet panel 14. The filter cartridge assembly 2 is partially disposed in the movable sleeve 8, and partially disposed in the second inner housing 9. An outer peripheral side wall of the movable sleeve 8 and an inner side wall of the outer housing 1 are disposed in close contact with each other, and the sealing ring 65 is disposed therebetween. An inner peripheral side wall of the movable sleeve 8 and the outer peripheral side wall of the filter cartridge assembly 2 are also disposed in close contact with each other, and another sealing ring 65 is also disposed therebetween. Thus, when water flows in from the joint 13, the water can only enter the movable sleeve 8 and thereby enter the filter cartridge assembly 2, and cannot flow out from between the inner peripheral side wall of the movable sleeve 8 and the outer peripheral side wall of the filter cartridge assembly 2, or between the outer peripheral side wall of the movable sleeve 8 and the inner side wall of the outer housing 1, ensuring that the water flowing out from the water outlet 12 has undergone filtration treatment by the filter cartridge assembly 2. The water flowing out from the filter cartridge assembly 2 enters the second water passage chamber 93 through the through groove 263, and finally flows out from the water outlet panel 14.

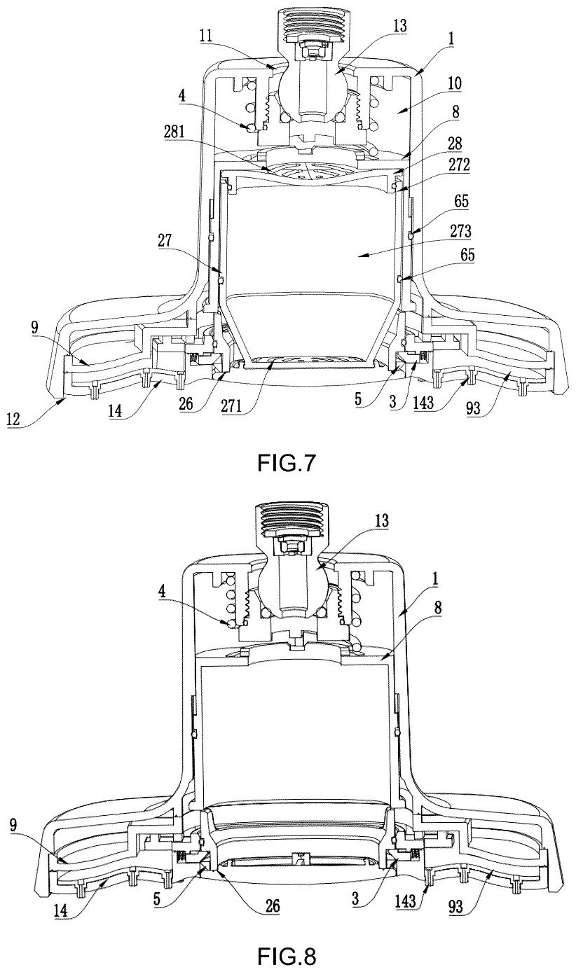

The filter mechanism according to embodiment 1 must have the filter cartridge cylinder 27 installed to function normally. In the present embodiment 2, by providing the movable sleeve 8, as shown in FIGS. 7-8, regardless of whether the filter cartridge cylinder 27 is installed, under the action of the first elastic member 4, the end face of said another end of the mounting seat 26 facing away from the pressing portion 22 always abuts against the end face of said another end of the movable sleeve 8 facing towards the pressing portion 22. Such arrangement allows the filter mechanism according to the present embodiment to function normally regardless of whether the filter cartridge cylinder 27 is installed, thereby meeting different usage needs of users. The installation and disassembly processes of the filter cartridge assembly 2 or the mounting seat 26 in the present embodiment are similar to those in embodiment 1, both through the deliberated cooperation of said at least two elastic snap-fit assemblies 3, the movable member 5, and the snap-fit groove 25, as well as the cooperation of the external pressing force F1 and the elastic force of the first elastic member 4. Regardless of installing or disassembling the filter cartridge assembly 2 or the mounting seat 26, it is only necessary to press the pressing portion 22 towards the first elastic member 4. Therefore, the detailed disassembly and installation processes are not repeated here.

The above-described embodiments are only the more specific and detailed explanations of only some but not all embodiments to implement the present invention. The above-described embodiments should not be understood as limitations to the patent scope of the present invention. It should be noted that, for those of ordinary skill in the art, different variations and improvements can be made without departing from the concept of the present invention, and should also fall within the protection scope of the present invention. Therefore, the protection scope of the patent of the present invention shall be defined by the appended claims.

1. A filter mechanism, comprising an outer housing, a filter cartridge assembly, and at least two elastic snap-fit assemblies; the outer housing is provided with a water inlet and a water outlet; an accommodating cavity is provided inside the outer housing; the filter cartridge assembly is disposed in the accommodating cavity and is detachably connected to the accommodating cavity via said at least two elastic snap-fit assemblies; one end of the filter cartridge assembly is provided with a pressing portion, and the pressing portion extends out of the accommodating cavity; a first elastic member is disposed between another end of the filter cartridge assembly facing away from the pressing portion and the outer housing; a periphery of the filter cartridge assembly is provided with a snap-fit groove; said at least two elastic snap-fit assemblies are capable of extending into the snap-fit groove; a movable member is movably disposed in the snap-fit groove; under an action of an external pressing force and/or an elastic force of the first elastic member, the filter cartridge assembly is capable of moving relative to the accommodating cavity; during movement of the filter cartridge assembly relative to the accommodating cavity, each of said at least two elastic snap-fit assemblies is capable of moving between an extended position and a retracted position under action of the movable member, and the movable member is capable of moving in the snap-fit groove under action of said at least two elastic snap-fit assemblies.

2. The filter mechanism of claim 1, wherein at least two installation grooves are provided in the accommodating cavity corresponding to a position of the snap-fit groove when the filter cartridge assembly is installed, and each of said at least two installation grooves is installed with a respective one of said at least two elastic snap-fit assemblies.

3. The filter mechanism of claim 1, wherein each of said at least two elastic snap-fit assemblies comprises at least one second elastic member and a snap-fit block connected to an end of said at least one second elastic member facing towards the filter cartridge assembly; the snap-fit block is capable of extending into the snap-fit groove during the extended position of a corresponding elastic snap-fit assembly; an end of the snap-fit block facing towards the filter cartridge assembly is provided with a first inclined surface, and an outer end of the movable member facing away from the filter cartridge assembly is provided with a second inclined surface corresponding to the first inclined surface.

4. The filter mechanism of claim 3, wherein along a direction from the pressing portion to the first elastic member, a width between the first inclined surface and a central axis of the filter cartridge assembly gradually decreases, and conversely, a width between the second inclined surface and the central axis of the filter cartridge assembly gradually increases.

5. The filter mechanism of claim 1, wherein the filter cartridge assembly comprises a filter cartridge cylinder; an interior of the filter cartridge cylinder is provided with a filter material accommodating cavity; one end of the filter cartridge cylinder communicates with the water inlet, and another end of the filter cartridge cylinder communicates with the water outlet.

6. The filter mechanism of claim 5, wherein said one end of the filter cartridge cylinder is provided with a first opening, and said another end of the filter cartridge cylinder is provided with a plurality of first through apertures; a filter cartridge cover is detachably connected at the first opening, and the filter cartridge cover is provided with a plurality of second through apertures.

7. The filter mechanism of claim 5, wherein the filter cartridge assembly further comprises a mounting seat; an interior of the mounting seat is provided with a mounting cavity; said another end of the filter cartridge cylinder which is proximal to the pressing portion is detachably disposed in the mounting cavity and communicates with the mounting cavity; a through groove is provided on the mounting seat or between the mounting seat and the filter cartridge cylinder; the mounting cavity communicates with the water outlet through the through groove; the snap-fit groove is disposed on a peripheral side wall of the mounting seat; the pressing portion is disposed at one end of the mounting seat facing away from the first elastic member.

8. The filter mechanism of claim 7, wherein the filter cartridge assembly further comprises an aromatherapy assembly detachably disposed in the mounting cavity.

9. The filter mechanism of claim 7, wherein the filter cartridge assembly further comprises a movable sleeve; the movable sleeve is disposed in the accommodating cavity; one end of the movable sleeve facing away from the pressing portion communicates with the water inlet, and another end of the moveable sleeve facing towards the pressing portion is provided with a second opening; said one end of the filter cartridge cylinder facing away from the pressing portion is detachably inserted into the movable sleeve through the second opening; the first elastic member is disposed between said one end of the movable sleeve facing away from the pressing portion and the outer housing; an end face of another end of the mounting seat facing away from the pressing portion abuts against an end face of another end of the movable sleeve facing towards the pressing portion; under the action of the external pressing force and/or the elastic force of the first elastic member, the movable sleeve is capable of moving relative to the accommodating cavity.
